(19) United States
(12) Patent Application Publication
(10) Pub. No.: US 2026/0178472 A1
(43) Pub. Date: Jun. 25, 2026

(54) METHOD AND ELECTRONIC DEVICE WITH TRAINING MODEL DATA PROCESSING

(71) Applicant: Samsung Electronics Co., Ltd., Suwon-si (KR)

(72) Inventors: Jihye KIM, Suwon-si (KR); Sungjoo GO, Suwon-si (KR); Jongseok KIM, Suwon-si (KR); Do-Ha HWANG, Suwon-si (KR); Jaeyoon LEE, Suwon-si (KR)

(73) Assignee: Samsung Electronics Co., Ltd., Suwon-si (KR)

(21) Appl. No.: 19/214,397

(22) Filed: May 21, 2025

(30) Foreign Application Priority Data
Dec. 19, 2024 (KR) 10-2024-0191643

(51) Int. Cl. G06F 11/3668

(52) U.S. Cl. CPC G06F 11/3688

(57) ABSTRACT

A processor-implement method includes obtaining a dataset comprising data pairs comprising code and a code description, performing first verification based on a target code description of a target data pair and a test code description generated by inputting target code of the target data pair among the data pairs to a language model, performing second verification based on the target code of the target data pair and test code generated by inputting the target code description of the target data pair to the language model, and updating the dataset based on the first verification and the second verification on the target data pair.

### CROSS-REFERENCE TO RELATED APPLICATIONS

This application claims the benefit under 35 USC § 119(a) of Korean Patent Application No. 10-2024-0191643, filed on Dec. 19, 2024 in the Korean Intellectual Property Office, the entire disclosure of which is incorporated herein by reference for all purposes.

### BACKGROUND

### 1. Field

The following description relates to a method and electronic device with training model data processing.

### 2. Description of Related Art

Tasks in various application fields including user experience, art, or development may be performed using a generative artificial intelligence (AI) model, such as a large language model (LLM). The LLM may generate text corresponding to a given prompt. The LLM may often be trained based on a dataset including a pair of input data and output data to generate output data that matches the user's intention.

In the programming technical field, the LLM may be used and for example, the LLM may generate code (or an instruction) as a solution to a problem situation or an instruction of a user, may generate a description or a comment in a natural language on the existing code, or may analyze and modify code including a bug.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implement method includes obtaining a dataset comprising data pairs comprising code and a code description, performing first verification based on a target code description of a target data pair and a test code description generated by inputting target code of the target data pair among the data pairs to a language model, performing second verification based on the target code of the target data pair and test code generated by inputting the target code description of the target data pair to the language model, and updating the dataset based on the first verification and the second verification on the target data pair.

The performing of the first verification may include generating the test code description by inputting the target code of the target data pair to the language model, determining a first distance score between the test code description and the target code description of the target data pair, and performing the first verification based on the first distance score.

The performing of the first verification may include generating a plurality of test code descriptions by inputting the target code of the target data pair to the language model, determining first distance scores between each of the plurality of test code descriptions and the target code description of the target data pair, and performing the first verification based on the plurality of first distance scores.

The performing of the second verification may include generating the test code by inputting the target code description of the target data pair to the language model, determining a second distance score between the test code and the target code of the target data pair, and performing the second verification based on the second distance score.

The performing of the second verification may include generating a plurality of test code by inputting the target code description of the target data pair to the language model, determining second distance scores between each of the plurality of test code and the target code of the target data pair, and performing the second verification based on the plurality of second distance scores.

The updating of the dataset based on the first verification and the second verification on the target data pair may include, in response to the first verification and the second verification on the target data pair being successful, keeping the target data pair in the dataset.

The keeping of the target data pair in the dataset in response to the first verification and the second verification on the target data pair being successful may include, in response to the first verification and the second verification on the target data pair and operational verification on the target code being successful, keeping the target data pair in the dataset.

The updating of the dataset based on the first verification and the second verification on the target data pair may include, in response to either one or both of the first verification and the second verification on the target data pair having failed, removing the target data pair from the dataset.

The method may include updating the dataset by performing the first verification and the second verification on each of data pairs other than the target data pairs among the data pairs.

The method may include training the language model using the updated dataset.

The method may include performing operational verification on the target code of the target data pair, and in response to the operational verification on the target code having failed, generating fixed code by inputting the target code to the language model, wherein the first verification is performed based on the target code description and a test code description generated by inputting the fixed code to the language model, and wherein the second verification is performed based on the fixed code and the test code generated by inputting the target code description to the language model.

The obtaining of the dataset may include generating the dataset by inputting code snippets to the language model or a language model that is different from the language model.

In one or more general aspects, a non-transitory computer-readable storage medium may store code that, when executed by one or more processors, configures the one or more processors to perform any one, any combination, or all of operations and/or methods disclosed herein.

In one or more general aspects, an electronic device includes one or more processors configured to obtain a dataset comprising data pairs comprising code and a code description, perform first verification based on a target code description of a target data pair and a test code description generated by inputting target code of the target data pair among the data pairs to a language model, perform second verification based on the target code of the target data pair and test code generated by inputting the target code description of the target data pair to the language model, and update the dataset based on the first verification and the second verification on the target data pair.

For the performing of the first verification, the one or more processors may be configured to generate the test code description by inputting the target code of the target data pair to the language model, determine a first distance score between the test code description and the target code description of the target data pair, and perform the first verification based on the first distance score.

For the performing of the second verification, the one or more processors may be configured to generate the test code by inputting the target code description of the target data pair to the language model, determine a second distance score between the test code and the target code of the target data pair, and perform the second verification based on the second distance score.

For the updating of the dataset based on the first verification and the second verification on the target data pair, the one or more processors may be configured to, in response to the first verification and the second verification on the target data pair being successful, keep the target data pair in the dataset.

For the keeping of the target data pair in the dataset when the first verification and the second verification on the target data pair are successful, the one or more processors may be configured to, in response to the first verification and the second verification on the target data pair and operational verification on the target code being successful, keep the target data pair in the dataset.

For the updating of the dataset based on the first verification and the second verification on the target data pair, the one or more processors may be configured to, in response to either one or both of the first verification and the second verification on the target data pair having failed, remove the target data pair from the dataset.

The one or more processors may be configured to train the language model using the updated dataset.

Other features and aspects will be apparent from the following detailed description, the drawings, and the claims.

### BRIEF DESCRIPTION OF THE DRAWINGS

FIG. 1 is a schematic diagram of a data processing system for model training, according to one or more embodiments.

FIG. 2 is a diagram illustrating a dataset for model training, according to one or more embodiments.

FIG. 3 is a block diagram of an electronic device, according to one or more embodiments.

FIG. 4 is a flowchart of a method of updating a dataset, according to one or more embodiments.

FIG. 5 is a flowchart of a first verification method, according to one or more embodiments.

FIG. 6 is a flowchart of a second verification method, according to one or more embodiments.

FIG. 7 is a flowchart of a method of updating a dataset, according to one or more embodiments.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on,” “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which the present disclosure pertains and based on an understanding of the disclosure of the present application. It will be further understood that terms, such as those defined in commonly-used dictionaries, should be interpreted as having a meaning that is consistent with their meaning in the context of the relevant art and the disclosure of the present application, and will not be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Hereinafter, embodiments will be described in detail with reference to the accompanying drawings. When describing the embodiments with reference to the accompanying drawings, like reference numerals refer to like elements and a repeated description related thereto will be omitted.

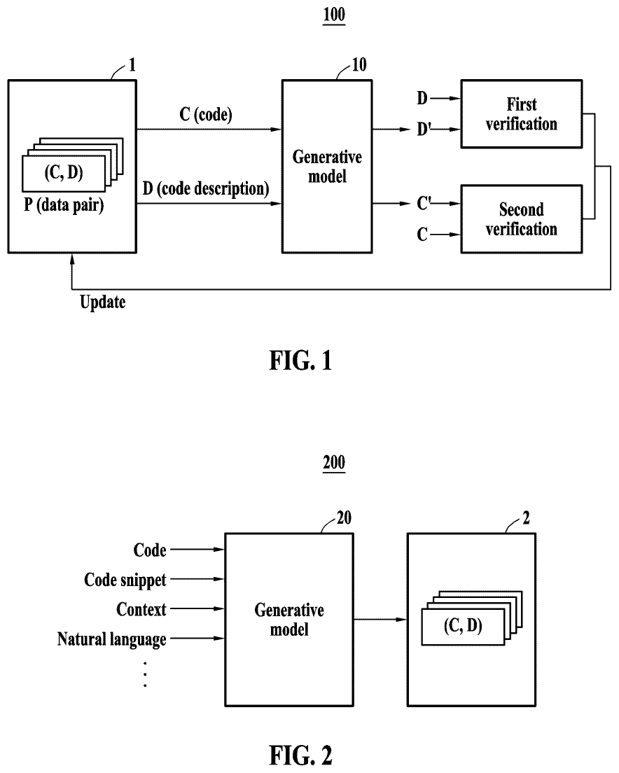

FIG. 1 is a schematic diagram of a data processing system for model training, according to one or more embodiments.

A data processing system for model training (hereinafter, also referred to as “the system”) 100 according to one or more embodiments may include a generative model 10.

The generative model 10 may be an artificial intelligence (AI) neural network for generating new data based on a user input. The generative model 10 may include a language generation model (e.g., a large language model (LLM) and/or a multimodal generative model (e.g., a large multimodal model (LMM)).

The system 100 may include an AI framework. The AI framework may receive a user input. The AI framework may tune and control one or more components to perform an operation that aligns with an intent of the user based on the user input (e.g., a query of the user). For example, the AI framework may include a prompt generation component (e.g., a prompt design component), an application programming interfaces (APIs)/plugins management component, and a refiner component.

In the system 100, the received user input may be transmitted to the prompt generation component. The prompt generation component may be used to generate a prompt suitable for an input to the generative model 10, based on the user input. The prompt generation component may be an AI component using a machine learning algorithm and/or a neural network. The prompt generation component may generate an improved prompt by learning over time. The prompt generation component may provide the generated prompt to the generative model 10.

The APIs/plugins management component may communicate with an external information source based on a request for additional information when the user input is transmitted to the generative model 10. The APIs/plugins management component may establish a communication channel to communicate with the outside of the system 100 via an API. The APIs/plugins management component may access various data sources via the communication channel. For example, the APIs/plugins management component may be used to send a request to another component (e.g., an application/service component) that provides feedback (or a response) according to the prompt. The obtained information may be used to generate a prompt by the prompt generation component together with the user input and/or may be used as an input to the generative model 10.

The refiner component may at least partially tune (or adjust or change) a result obtained from (or output from or generated by) the generative model 10. For example, the refiner component may determine a relevance (e.g., a score) between an output (e.g., content) of the generative model 10 and the user input. For example, the refiner component may determine whether the output includes biased information (e.g., selective information). The refiner component may determine a matching level between the output of the generative model 10 and the user input (e.g., the intent of the user input). When the refiner component determines that the output of the generative model 10 does not correspond to the user input (e.g., when the score or matching level is less than or equal to a threshold value), the refiner component may modify the output to correspond to the user input.

In the programming technical field, a deep learning-based model, such as the generative model 10, that may generate code as a solution to a problem situation and/or an instruction of the user may be used. The deep learning-based model may generate a description and/or a comment in a natural language on the existing code and/or may analyze and modify code including a bug. For example, to train and/or fine-tune the deep learning-based model, arbitrary code and a dataset including a code description corresponding to the code may be used. The code description may be text data that defines a project solved by the matching code, instructs to write the code, and/or indicates specification for describing a syntax of the code.

To train and/or tune the deep learning-based model, such as the generative model 10, the code description that matches the code may be sufficiently secured and a valid dataset that correctly reflects matching data between the code and the code description may be obtained. Lack of validity verification of the code and the code description used for model training, as in a typical method and device, may cause performance degradation of the model. An example of the dataset for model training is further described with reference to FIG. 2.

The system 100 according to one or more embodiments may obtain a dataset 1. The dataset 1 may include data pairs including code and a code description. In each data pair, the code may be generated based on the code description and/or may be computer-readable data that the code description defines and/or describes. In each data pair, the code description may be text data that defines a project solved by the code, instructs to write the code, and/or indicates specification for describing a syntax of the code.

The system 100 may verify whether the data pairs of the dataset 1 are valid. The system 100 may determine the validity of a data pair by verifying whether the code and the code description of the data pair correctly reflect each data piece.

The system 100 may perform first verification and second verification on each of the data pairs of the dataset 1 using the generative model 10. Hereinafter, the first verification and the second verification on a data pair P including code C and a code description D are described.

In the first verification, the system 100 may obtain (e.g., generate) a test code description D′ by inputting the code C of the data pair P to the generative model 10. It may be estimated that the test code description D′ may appropriately reflect the code C in proportion to the performance of the generative model 10. The system 100 may perform the first verification by comparing the code description D of the data pair P with the test code description D′. For example, in the first verification, whether the code description D of the data pair P sufficiently reflects the code C as the test code description D′ may be determined.

In the second verification, the system 100 may obtain test code C′ by inputting the code description D of the data pair P to the generative model 10. It may be estimated that the test code C′ may appropriately reflect the code description D in proportion to the performance of the generative model 10. The system 100 may perform the second verification by comparing the code C of the data pair P with the test code C′. For example, in the second verification, whether the code C of the data pair P sufficiently reflects the code description D as the test code C′ may be determined.

When both the first verification and the second verification on the data pair P are successful, the system 100 may determine the data pair P to be valid data. When at least one of the first verification and the second verification has failed, the system 100 may determine the data pair P to be invalid data.

The system 100 may filter the invalid data by performing the first verification and the second verification on each data pair of the dataset 1. The system 100 may update the dataset 1 based on the first verification and the second verification on each data pair.

FIG. 2 is a diagram illustrating a dataset for model training, according to one or more embodiments.

A system for processing data for model training (hereinafter, also referred to as “the system”) 200 according to one or more embodiments may include a generative model 20.

The generative model 20 may be an AI neural network for generating new data based on a user input. The generative model 20 may include a language generative model (e.g., the LLM) and/or a multimodal generative model (e.g., the LMM). The generative model 20 may be the same as or different from the generative model 10 of FIG. 1. Any repeated description of the generative model 10 provided above with reference to FIG. 1 is omitted.

In one or more embodiments, the system 200 may include a dataset 2 (e.g., the dataset 1 of FIG. 1) using the generative model 20. The dataset 2 may include data pairs including code and a code description. In each data pair, the code may be generated based on the code description and/or may be computer-readable data that the code description defines and/or describes. In each data pair, the code description may be text data that defines a project solved by the code, instructs to write the code, and/or indicates specification for describing a syntax of the code.

The system 200 may provide natural language such as source code, and/or a code snippet extracted from the source code, contextual information, and/or an instruction, to the generative model 20 as input data. For example, the system 200 may input, to the generative model 20, a prompt template for writing a coding problem and a solution thereto based on the code snippet and the contextual information that compensates for the intent and background of the code snippet. The system 200 may generate the dataset 2 including the coding problem (e.g., the code description) and the solution thereto (e.g., the code) obtained as output data of the generative model 20.

In one or more embodiments, the system 200 may obtain an arbitrary code-natural language dataset. The system 200 may generate the dataset 2 based on an existing code-natural language dataset. The system 200 may generate a code-code description data pair by data augmentation based on the existing code-natural language dataset. For example, the system 200 may generate a new code-code description data pair by similarly replicating and/or transforming the context of the existing dataset using a variational autoencoder (VAE). For example, the system 200 may search the existing code-natural language dataset for a similar coding problem and a solution thereto by using retrieval-augmented generation (RAG) and may generate a new code-code description data pair.

In one or more embodiments, the system 200 may generate the dataset 2 using a pre-trained code-natural language (or code-language) model based on a transformer that supports bidirectional understanding. The system 200 may generate the new code-code description data pair using a code-language model that supports graph representation for syntactic and semantic understanding.

In one or more embodiments, the system 200 may generate the dataset 2 based on obtaining a code description written by a human annotator for arbitrary code. The system 200 may also generate the dataset 2 based on the code and the code description written by the human annotator.

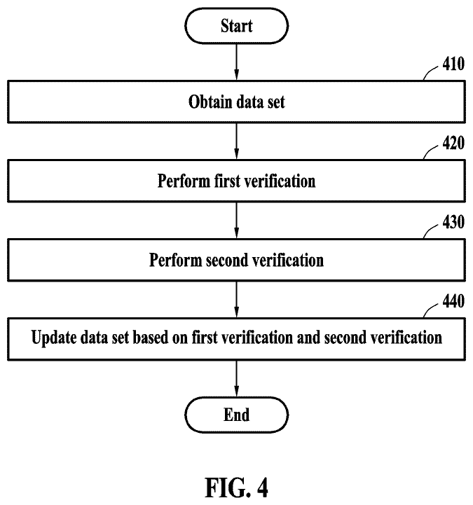

To generate code as a solution to the problem situation and/or the user's instruction, generate a description and/or a comment in a natural language on the existing code, and/or train and/or tune a deep learning-based model for analyzing and modifying a code including a bug, the code description matching the code may be sufficiently secured and a valid dataset that correctly reflect the matching data between the code and the code description may be obtained. Lack of validity verification of the code and the code description used for model training, as in the typical method and device, may cause performance degradation of the model. An example of a method of verifying the dataset 2 is further described with reference to FIG. 4.

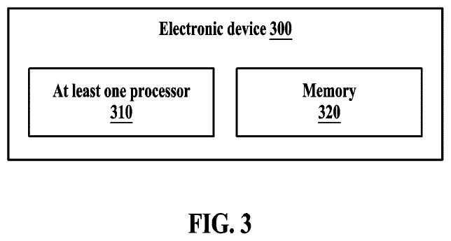

FIG. 3 is a block diagram of an electronic device, according to one or more embodiments.

An electronic device 300 according to one or more embodiments may include at least one processor (e.g., one or more processors, and hereinafter, also referred to as “the processor”) 310 including a processing circuitry and a memory 320 (e.g., one or more memories) including one or more storage media storing instructions. When the instructions are individually or collectively executed by the processor 310, the instructions may cause the electronic device 300 to perform at least a portion of the operations described herein with reference to FIGS. 1 to 7. For example, the memory 320 may be or include a non-transitory computer-readable storage medium storing code that, when executed by the processor 310, configures the processor 310 (or causes the electronic device 300) to perform any one, any combination, and/or all of operations and/or methods described herein with reference to FIGS. 1 to 7.

The electronic device 300 may further include a communicator connected to the processor 310 and the memory 320 to transmit and receive data. The communicator may be connected to other external devices to transmit and receive data. Hereinafter, the expression transmit and receive “A” may refer to transmit and receive “information and/or data indicating A”.

The communicator may be implemented by a circuitry in the electronic device 300. For example, the communicator may include an internal bus and an external bus. For another example, the communicator may be an element to connect the electronic device 300 to an external device. The communicator may be an interface. The communicator may receive data from an external device and may transmit the data to the processor 310 and the memory 320.

The processor 310 may process data received by the communicator and/or data stored in the memory 320. The “processor” may be a data processing device implemented by hardware including a circuit having a physical structure to perform desired operations. For example, the desired operations may include code and/or instructions included in a program. For example, the hardware-implemented data processing device may include a microprocessor, a central processing unit (CPU), a graphics processing unit (GPU), a processor core, a multi-core processor, a multiprocessor, an application-specific integrated circuit (ASIC), and a field-programmable gate array (FPGA).

The processor 310 may control other components (e.g., a hardware and/or software component) of the electronic device 300 and may perform various data processing and/or computations. As at least a portion of data processing and/or computation, the processor 310 may store an instruction and/or data received from another component (e.g., the communicator) in at least a portion of the memory 320, may process the instruction and/or data stored in the memory 320, and may store resulting data in the memory 320. The operations performed by the processor 310 may be substantially the same as the operations of the electronic device 300.

The memory 320 may store information necessary for the processor 310 to perform a processing operation. The memory 320 (one or more storage media included in the memory 320) may store instructions executed by the processor 310 and may store associated information while executing the software and/or program in the electronic device 300. For example, the memory 320 may include one or more memories that are volatile and/or non-volatile, such as random access memory (RAM), dynamic RAM (DRAM), static RAM (SRAM), non-volatile RAM (NVRAM), persistent memory (PMEM), magneto-resistive random memory (MRAM), high bandwidth memory (HBM), and 3DXPoint.

The electronic device 300 may be connected to an external memory via the communicator. For example, the external memory may include at least one volatile memory, non-volatile memory, RAM, flash memory, a hard disk drive, and an optical disk drive. The external memory may store a set of instructions (e.g., software) to operate the electronic device 300. The set of instructions to operate the electronic device 300 may be executed by the processor 310.

In one or more embodiments, the generative model 10 and/or the AI framework described with reference to FIG. 2 may be included in the electronic device 300. For example, the generative model 10 and/or the AI framework may be included in a module including the processing circuitry in the electronic device 300. For example, a module including the processing circuitry may be operatively coupled to at least one processor (e.g., the processor 310) of the electronic device 300.

FIG. 4 is a flowchart of a method of updating a dataset, according to one or more embodiments.

According to one or more embodiments, operations 410 to 440 described below may be performed by an electronic device (e.g., the electronic device 300 of FIG. 3). The electronic device may include at least some of the components of the electronic device 300 described with reference to FIG. 3. For example, the electronic device may include at least one processor (e.g., the at least one processor 310 of FIG. 3). The electronic device may include a memory (e.g., the memory 320 of FIG. 3).

In operation 410, the electronic device may obtain a dataset including data pairs including code and a code description.

In each data pair of the dataset, the code may be generated based on the code description and/or may be computer-readable data that the code description defines and/or describes. In each data pair of the dataset, the code description may be text data that defines a project solved by the code, instructs to write the code, and/or indicates specification for describing a syntax of the code.

As described with reference to FIG. 2, the electronic device may obtain a dataset generated in various schemes. For example, the electronic device may obtain a dataset generated using a language model (e.g., the generative model 10 of FIG. 1 and/or the generative model 20 of FIG. 2). For example, the electronic device may obtain a dataset generated by data augmentation based on an existing code-natural language dataset. For example, the electronic device may obtain a dataset generated using a pre-trained code-natural language model based on a transformer.

The language model used to generate a dataset and a language model used to update the dataset may be the same or different from each other. In other words, the electronic device may obtain a dataset by inputting code snippets to a language model described below in operations 420 and 430 or a language model that is different therefrom.

In one or more embodiments, the electronic device may include (or store) a language model. The language model may be embedded (or installed or deployed) in the electronic device. The electronic device may perform operations 420 and 430 using an on-device language model included in the electronic device.

In one or more embodiments, the electronic device may be connected to an external electronic device including (or storing) the language model, a system (e.g., the system 100 for data processing for model training of FIG. 1), and/or a server via direct (e.g., by wire) communication and/or wireless communication (e.g., Bluetooth, wireless fidelity (Wi-Fi) direct, and/or near field communication (NFC)). The electronic device may offload operations 420 and 430 from the external electronic device, the system, and/or the server. The electronic device may receive a result of performing operations 420 and 430 from the external electronic device, the system, and/or the server.

Although FIG. 4 illustrates that operations 410 to 440 are sequentially performed, the order of one or more of the operations may be changed, one or more of the operations may be omitted, two or more of the operations may be performed in parallel or simultaneously, and/or other operations may be additionally performed without departing from the spirit and scope of the example embodiments described herein.

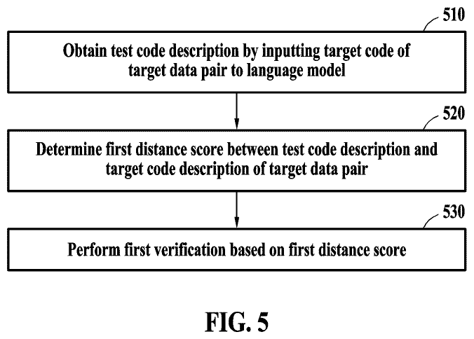

In operation 420, the electronic device may perform first verification based on a target code description of a target data pair and a test code description obtained by inputting target code of the target data pair among data pairs of the dataset to the language model. An example of a method of first verification is further described with reference to FIG. 5.

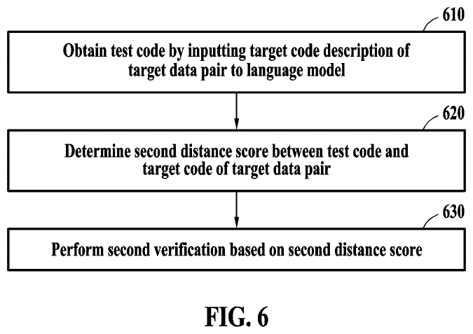

In operation 430, the electronic device may perform second verification based on target code of the target data pair and test code obtained by inputting the target code description of the target data pair among data pairs of the data set to the language model. An example of a method of second verification is further described with reference to FIG. 6.

In operation 440, the electronic device may update the dataset based on the first verification and the second verification on the target data pair.

When the first verification and the second verification on the target data pair are successful, the electronic device may keep the target data pair in the dataset. For example, when the first verification and the second verification on the target data pair are successful, the electronic device may update the dataset by identifying the target data pair as a valid data pair. When at least one of the first verification and the second verification on the target data pair has failed, the electronic device may remove the target data pair from the dataset.

The electronic device may update the dataset by performing the first verification and the second verification on each of the data pairs other than the target data pair. The electronic device may update the dataset by removing (or filtering) the data pair that fails at least one of the first verification and/or the second verification from the data pairs of the dataset. The updated dataset may include valid data pairs.

In one or more embodiments, when the first verification and the second verification on the target data pair and operational verification on the target code are successful, the electronic device may keep the target data pair in the dataset.

The operational verification on the target code may include a static analysis, a dynamic analysis, and/or runtime verification on the code. For example, when the target code of the target data pair is free of syntax errors, potential defects, and runtime errors and is bug-free executable, the electronic device may determine that the operational verification on the target code is successful. When at least one of the problems described above occurs in the target code of the target data pair and/or any other problem (e.g., overflow and/or noncompliance with code standards) occurs, the electronic device may determine that the operational verification on the target code has failed.

Even when the first verification and the second verification on the target data pair are successful, when the operational verification on the target code has failed, the electronic device may remove the target data pair from the target dataset.

In operation 440, the electronic device may train the language model using the updated dataset. For example, in operation 440, the electronic device may train the language model described in operations 420 and 430 using the updated dataset. For example, the electronic device may train a model that is different from the language model described above using the update dataset.

In one or more embodiments, the electronic device may generate a data pair including code and a code description in response to a request of the user using the language model. For ease of description, the code and the code description generated in response to the user's request may be referred to as the “user code” and the “user code description”, respectively. For example, the electronic device may obtain the data pair including the user code and the user code description by inputting the user's request to the language model based on receiving the user's request for an arbitrary coding problem and/or a solution. The electronic device may also input the user's request to the language model based on a determined prompt template that instructs to generate the user code and the user code description in response to the user's request.

The electronic device may perform the first verification and the second verification on the data pair including the user code and the user code description. The first verification (operation 420) may be performed based on the user code description and a test code description obtained by inputting the user code to the language model. The second verification (operation 430) may be performed based on adjusted code and test code obtained by inputting the user code description to the language model. When the first verification and the second verification on the data pair including the user code and the user code description are successful, the electronic device may add (or keep) the data pair in a dataset (e.g., the dataset 1 of FIG. 1) for training the language model.

FIG. 5 is a flowchart of a first verification method, according to one or more embodiments. Operations 510 to 530 of FIG. 5 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

According to one or more embodiments, operations 510 to 530 described below may be performed by an electronic device (e.g., the electronic device 300 of FIG. 3). The electronic device may include at least some of the components of the electronic device 300 described with reference to FIG. 3. For example, the electronic device may include at least one processor (e.g., the at least one processor 310 of FIG. 3). The electronic device may include a memory (e.g., the memory 320 of FIG. 3).

According to one or more embodiments, operation 420 of performing the first verification of FIG. 4 may include operations 510 to 530.

In operation 510, the electronic device may obtain a test code description by inputting target code of a target data pair to a language model (e.g., the generative model 10 of FIG. 1 and/or the generative model 20 of FIG. 2).

The electronic device may input the target code of the target data pair to the language model based on a determined prompt template that instructs to generate the test code description. The electronic device may obtain the test code description by inputting the target code to the language model based on a determined prompt template, for example, “You are a programming expert. Analyze the following code and generate a detailed description: {target code}”.

In operation 520, the electronic device may determine a first distance score between the test code description and the target code description of the target data pair.

The electronic device may obtain embedding vectors output by a text encoder by inputting the test code description and the target code description to the text encoder (or a vector encoder based on the language model). The text encoder may be trained to extract feature information (e.g., a grammatical structure, a relation between words, semantic information, etc.) by processing the input text and convert the extracted feature information into a high-dimensional embedding vector. The text encoder may be one of, for example, bidirectional encoder representations from transformers (BERT), contrastive language-image pretraining (CLIP), universal sentence encoder (USE), and/or generative pre-trained transformer (GPT), but is not limited thereto.

In an embedding, the electronic device may determine a distance (or difference) between embedding vectors obtained by encoding the test code description and the target code description, respectively. The electronic device may determine the distance between the embedding vectors to be the first distance score.

For example, the electronic device may determine a Euclidean distance between the embedding vectors obtained by encoding the test code description and the target code description, respectively. The electronic device may determine the Euclidean distance between the embedding vectors to be the first distance score.

For example, the electronic device may normalize a distance vector (or a difference vector) between the embedding vectors obtained by encoding the test code description and the target code description, respectively, and may determine a size (e.g., norm) of the normalized distance vector. The electronic device may determine the size of the normalized distance vector to be the first distance score.

In one or more embodiments, the electronic device may determine a similarity between the test code description and the target code to be the first distance score.

For example, the electronic device may determine a match rate (e.g., an n-gram match rate) between the test code description and the target code description. The electronic device may determine the match rate between the test code description and the target code description to be the first distance score.

For example, the electronic device may determine a cosine similarity between the embedding vectors obtained by encoding the test code description and the target code description, respectively. The electronic device may determine the cosine similarity between the embedding vectors to be the first distance score.

For example, the electronic device may determine a distance similarity (or a distance score) by subtracting, from a reference value, the size of the distance vector (or the size of the normalized distance vector) of the embedding vectors obtained by encoding the test code description and the target code description, respectively. Alternatively, the electronic device may determine the distance similarity by dividing the reference value by the size of the distance vector. The electronic device may determine the distance similarity to be the first distance score.

In operation 530, the electronic device may perform the first verification based on the first distance score.

When the first distance score satisfies a predetermined condition, the electronic device may determine that the first verification is successful.

For example, the electronic device may determine that the first verification is successful when the first distance score is less than (or less than or equal to) a predetermined threshold, wherein the first distance score is determined to be a distance (e.g., the Euclidean distance and/or the size of the normalized distance vector) between the embedding vectors obtained by encoding the test code description and the target code description, respectively.

For example, the electronic device may determine that the first verification is successful when the first distance score determined to be the similarity (e.g., the match rate, the cosine similarity, and/or the distance similarity) between the test code description and the target code description is greater than or equal to (or exceeds) a predetermined threshold.

When the first distance score does not satisfy the predetermined condition, the electronic device may determine that the first verification has failed.

For example, the electronic device may determine that the first verification has failed when the first distance score is greater than or equal to (or less than) the predetermined threshold, wherein the first distance score is determined to be the distance (e.g., the Euclidean distance and/or the size of the normalized distance vector) between the embedding vectors obtained by encoding the test code description and the target code description, respectively.

For example, the electronic device may determine that the first verification has failed when the first distance score determined to be the similarity (e.g., the match rate, the cosine similarity, and/or the distance similarity) between the test code description and the target code description is less than (or less than or equal to) a predetermined threshold.

In one or more embodiments, the electronic device may obtain a plurality of test code descriptions by inputting the target code of the target data pair to the language model. The electronic device may obtain the plurality of test code descriptions by inputting the target code to the language model based on a determined prompt template, for example, “You are a programming expert. Analyze the following code and generate n detailed descriptions: {target code}”. The electronic device may determine the first distance score between each of the plurality of test code descriptions and the target code description of the target data pair. The electronic device may perform the first verification based on the plurality of first distance scores.

The electronic device may determine that the first verification is successful when a mean of the plurality of first distance scores satisfies a predetermined condition.

For example, the electronic device may determine that the first verification is successful when the mean of the plurality of first distance scores is less than (or less than or equal to) a predetermined threshold, wherein the first distance scores are determined to be distances (e.g., the Euclidean distance and/or the size of the normalized distance vector) between each of the embedding vectors of the plurality of test code descriptions and the embedding vector of the target code description. For example, the electronic device may determine that the first verification is successful when the mean of the plurality of first distance scores determined to be the similarity (e.g., the match rate, the cosine similarity, and/or the distance similarity) between each of the plurality of test code descriptions and the target code description is greater than and/or equal to (or exceeds) a predetermined threshold.

When the mean of the plurality of first distance scores does not satisfy the predetermined condition, the electronic device may determine that the first verification has failed.

For example, the electronic device may determine that the first verification has failed when the mean of the plurality of first distance scores is greater than or equal to (or less than) a predetermined threshold, wherein the first distance scores are determined to be distances (e.g., the Euclidean distance and/or the size of the normalized distance vector) between each of the embedding vectors of the plurality of test code descriptions and the embedding vector of the target code description. For example, the electronic device may determine that the first verification has failed when the plurality of first distance scores determined to be the similarity (e.g., the match rate, the cosine similarity, and/or the distance similarity) between each of the plurality of test code descriptions and the target code description is less than (or less than and/or equal to) a predetermined threshold.

FIG. 6 is a flowchart of a second verification method, according to one or more embodiments. Operations 610 to 630 of FIG. 6 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

According to one or more embodiments, operations 610 to 630 described below may be performed by an electronic device (e.g., the electronic device 300 of FIG. 3). The electronic device may include at least some of the components of the electronic device 300 described with reference to FIG. 3. For example, the electronic device may include at least one processor (e.g., the at least one processor 310 of FIG. 3). The electronic device may include a memory (e.g., the memory 320 of FIG. 3).

According to one or more embodiments, operation 430 of performing the second verification of FIG. 4 may include operations 610 to 630.

In operation 610, the electronic device may obtain test code by inputting a target code description of a target data pair to a language model (e.g., the generative model 10 of FIG. 1 and/or the generative model 20 of FIG. 2).

The electronic device may input the target code description of the target data pair to the language model based on a determined prompt template that instructs to generate the test code. The electronic device may obtain the test code by inputting the target code description to the language model based on a determined prompt template, for example, “You are a programming expert. Analyze the following natural language description and generate code (or a code snippet) satisfying the described requirement: {target code description}”.

In operation 620, the electronic device may determine a second distance score between the test code and the target code of the target data pair.

The electronic device may obtain embedding vectors output by a text encoder (or a vector encoder based on the language model) by inputting the test code and the target code to the text encoder. Any repeated description of the text encoder provided above with reference to FIG. 5 is omitted.

In one or more embodiments, the electronic device may determine a distance (or difference) between the embedding vectors obtained by encoding the test code and the target code, respectively. The electronic device may determine the distance between the embedding vectors to be the second distance score.

For example, the electronic device may determine a Euclidean distance between the embedding vectors obtained by encoding the test code and the target code, respectively. The electronic device may determine the Euclidean distance between the embedding vectors to be the second distance score.

For example, the electronic device may normalize a distance vector (or a difference vector) between the embedding vectors obtained by encoding the test code and the target code, respectively, and may determine a size (e.g., norm) of the normalized distance vector. The electronic device may determine the size of the normalized distance vector to be the second distance score.

In one or more embodiments, the electronic device may determine a similarity between the test code and the target code to be the second distance score.

For example, the electronic device may determine a match rate (e.g., an n-gram match rate) between the test code and the target code. The electronic device may determine the match rate in which a syntax structure and semantic relations are reflected, based on an abstract syntax tree (AST) and a data flow of the test code and the target code. The electronic device may determine the match rate between the test code and the target code to be the second distance score.

For example, the electronic device may determine a cosine similarity between the embedding vectors obtained by encoding the test code and the target code, respectively. The electronic device may determine the cosine similarity between the embedding vectors to be the second distance score.

For example, the electronic device may determine a distance similarity (or a distance score) by subtracting, from a reference value, the size of the distance vector (or the size of the normalized distance vector) of the embedding vectors obtained by encoding the test code and the target code, respectively. Alternatively, the electronic device may determine the distance similarity by dividing the reference value by the size of the distance vector. The electronic device may determine the distance similarity to be the second distance score.

In operation 630, the electronic device may perform the second verification based on the second distance score.

When the second distance score satisfies a predetermined condition, the electronic device may determine that the second verification is successful.

For example, the electronic device may determine that the second verification is successful when the second distance score is less than (or less than or equal to) a predetermined threshold, wherein the first distance score is determined to be a distance (e.g., the Euclidean distance and/or the size of the normalized distance vector) between the embedding vectors obtained by encoding the test code and the target code, respectively.

For example, the electronic device may determine that the second verification is successful when the second distance score determined to be the similarity (e.g., the match rate, the cosine similarity, and/or the distance similarity) between the test code and the target code is greater than or equal to (or exceeds) a predetermined threshold.

When the second distance score does not satisfy the predetermined condition, the electronic device may determine that the second verification has failed.

For example, the electronic device may determine that the second verification has failed when the second distance score is greater than or equal to (or less than) the predetermined threshold, wherein the first distance score is determined to be the distance (e.g., the Euclidean distance and/or the size of the normalized distance vector) between the embedding vectors obtained by encoding the test code and the target code, respectively.

For example, the electronic device may determine that the second verification has failed when the second distance score determined to be the similarity (e.g., the match rate, the cosine similarity, and/or the distance similarity) between the test code and the target code is less than (or less than or equal to) a predetermined threshold.

In one or more embodiments, the electronic device may obtain a plurality of test code by inputting the target code description of the target data pair to the language model. The electronic device may obtain the plurality of test code by inputting the target code description to the language model based on a determined prompt template, for example, “You are a programming expert. Analyze the following natural language description and generate n code (or code snippets) satisfying the described requirement: {target code description}”. The electronic device may determine the second distance score between each of the plurality of test code and the target code of the target data pair. The electronic device may perform the second verification based on the plurality of second distance scores.

The electronic device may determine that the second verification is successful when a mean of the plurality of second distance scores satisfies a predetermined condition.

For example, the electronic device may determine that the second verification is successful when the mean of the plurality of second distance scores is less than (or less than and/or equal to) a predetermined threshold, wherein the second distance scores are determined to be distances (e.g., the Euclidean distance and/or the size of the normalized distance vector) between each of the embedding vectors of the plurality of test code and the embedding vector of the target code. For example, the electronic device may determine that the second verification is successful when the mean of the plurality of second distance scores determined to be the similarity (e.g., the match rate, the cosine similarity, and/or the distance similarity) between each of the plurality of test code and the target code is greater than or equal to (or exceeds) a predetermined threshold.

When the mean of the plurality of second distance scores does not satisfy the predetermined condition, the electronic device may determine that the second verification has failed.

For example, the electronic device may determine that the second verification has failed when the mean of the plurality of second distance scores is greater than or equal to (or less than) a predetermined threshold, wherein the second distance scores are determined to be distances (e.g., the Euclidean distance and/or the size of the normalized distance vector) between each of the embedding vectors of the plurality of test code and the embedding vector of the target code. For example, the electronic device may determine that the second verification has failed when the plurality of second distance scores determined to be the similarity (e.g., the match rate, the cosine similarity, and/or the distance similarity) between each of the plurality of test code and the target code is less than (or less than or equal to) a predetermined threshold.

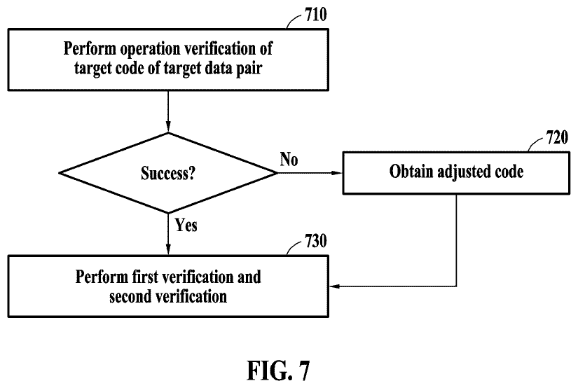

FIG. 7 is a flowchart of a method of updating a dataset, according to one or more embodiments. Operations 710 to 730 of FIG. 7 may be performed in the order and manner shown. However, the order of one or more of the operations may be changed, one or more of the operations may be omitted, two or more of the operations may be performed in parallel or simultaneously, and/or other operations may be additionally performed without departing from the spirit and scope of the example embodiments described herein.

According to one or more embodiments, operations 710 to 730 described below may be performed by an electronic device (e.g., the electronic device 300 of FIG. 3). The electronic device may include at least some of the components of the electronic device 300 described with reference to FIG. 3. For example, the electronic device may include at least one processor (e.g., the at least one processor 310 of FIG. 3). The electronic device may include a memory (e.g., the memory 320 of FIG. 3).

According to one or more embodiments, the electronic device may perform operations 710 before operation 420 of performing the first verification and operation 430 of performing the second verification of FIG. 4.

In operation 710, the electronic device may perform operational verification on the target code of the target data pair.

The operational verification on the target code may include a static analysis, a dynamic analysis, and/or runtime verification on the code. For example, when the target code of the target data pair is free of syntax errors, potential defects, and runtime errors and is bug-free executable, the electronic device may determine that the operational verification on the target code is successful. When at least one of the problems described above occurs in the target code of the target data pair and/or any other problem (e.g., overflow and/or noncompliance with code standards) occurs, the electronic device may determine that the operational verification on the target code has failed.

In operation 720, when the operational verification on the target code has failed, the electronic device may obtain fixed (adjusted) code by inputting the target code to the language model.

The electronic device may obtain the fixed code that may pass the operational verification by inputting the target code to the language model based on a determined prompt template, for example, “You are a software developer and a debugging expert. Analyze the following code, identify a problem (e.g., a syntax error, a potential defect, a runtime error, and/or a bug), and provide functional and error-free fixed code: {target code}”.

In response to operation 720 being performed, in operation 730, the electronic device may perform the first verification and the second verification on an updated target data pair including the fixed code and the target code description. The first verification (operation 420 of FIG. 4) may be performed based on the test code description and the target code description obtained by inputting the fixed code to the language model. The second verification (operation 430 of FIG. 4) may be performed based on the test code and the fixed code obtained by inputting the target code description to the language model. In another example, in response to operation 720 being performed, the electronic device may repeat the method using the adjusted code obtained in operation 720. For example, operation 720 may include updating the target code to be the obtained adjusted code, and in response to operation 720 being performed, the electronic device may perform operation 710 again using the updated target code. Accordingly, in an example, operations 710 and 720 may be iteratively performed until the operational verification on the target code is successful.

When the operational verification on the target code is successful in operation 710, in operation 730, the electronic device may perform the first verification and the second verification on the target data pair including the target code and the target code description. Any repeated description provided above with reference to FIG. 4 is omitted.

The electronic devices, processors, memories, electronic device 300, processor 310, and memory 320 described herein, including descriptions with respect to respect to FIGS. 1-7, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-7 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implement method comprising:
obtaining a dataset comprising data pairs comprising code and a code description;
performing first verification based on a target code description of a target data pair and a test code description generated by inputting target code of the target data pair among the data pairs to a language model;
performing second verification based on the target code of the target data pair and test code generated by inputting the target code description of the target data pair to the language model; and
updating the dataset based on the first verification and the second verification on the target data pair.

2. The method of claim 1, wherein the performing of the first verification comprises:
generating the test code description by inputting the target code of the target data pair to the language model;
determining a first distance score between the test code description and the target code description of the target data pair; and
performing the first verification based on the first distance score.

3. The method of claim 1, wherein the performing of the first verification comprises:
generating a plurality of test code descriptions by inputting the target code of the target data pair to the language model;
determining first distance scores between each of the plurality of test code descriptions and the target code description of the target data pair; and
performing the first verification based on the plurality of first distance scores.

4. The method of claim 1, wherein the performing of the second verification comprises:
generating the test code by inputting the target code description of the target data pair to the language model;
determining a second distance score between the test code and the target code of the target data pair; and
performing the second verification based on the second distance score.

5. The method of claim 1, wherein the performing of the second verification comprises:
generating a plurality of test code by inputting the target code description of the target data pair to the language model;
determining second distance scores between each of the plurality of test code and the target code of the target data pair; and
performing the second verification based on the plurality of second distance scores.

6. The method of claim 1, wherein the updating of the dataset based on the first verification and the second verification on the target data pair comprises, in response to the first verification and the second verification on the target data pair being successful, keeping the target data pair in the dataset.

7. The method of claim 6, wherein the keeping of the target data pair in the dataset in response to the first verification and the second verification on the target data pair being successful comprises, in response to the first verification and the second verification on the target data pair and operational verification on the target code being successful, keeping the target data pair in the dataset.

8. The method of claim 1, wherein the updating of the dataset based on the first verification and the second verification on the target data pair comprises, in response to either one or both of the first verification and the second verification on the target data pair having failed, removing the target data pair from the dataset.

9. The method of claim 1, further comprising updating the dataset by performing the first verification and the second verification on each of data pairs other than the target data pairs among the data pairs.

10. The method of claim 9, further comprising training the language model using the updated dataset.

11. The method of claim 1, further comprising:
performing operational verification on the target code of the target data pair; and
in response to the operational verification on the target code having failed, generating fixed code by inputting the target code to the language model,
wherein the first verification is performed based on the target code description and a test code description generated by inputting the fixed code to the language model, and
wherein the second verification is performed based on the fixed code and the test code generated by inputting the target code description to the language model.

12. The method of claim 1, wherein the obtaining of the dataset comprises generating the dataset by inputting code snippets to the language model or a language model that is different from the language model.

13. A non-transitory computer-readable storage medium storing code that, when executed by one or more processors, configures the one or more processors to perform the method of claim 1.

14. An electronic device comprising:
at least one processor comprising processing circuitry; and
memory comprising one or more storage media storing instructions that, when executed individually or collectively by the at least one processor, cause the electronic device to:
obtain a dataset comprising data pairs comprising code and a code description;
perform first verification based on a target code description of a target data pair and a test code description generated by inputting target code of the target data pair among the data pairs to a language model;
perform second verification based on the target code of the target data pair and test code generated by inputting the target code description of the target data pair to the language model; and
update the dataset based on the first verification and the second verification on the target data pair.

15. The electronic device of claim 14, wherein, for the performing of the first verification, the instructions, when executed individually or collectively by the at least one processor, further cause the electronic device to:
generate the test code description by inputting the target code of the target data pair to the language model;
determine a first distance score between the test code description and the target code description of the target data pair; and
perform the first verification based on the first distance score.

16. The electronic device of claim 14, wherein, for the performing of the second verification, the one or more processors are configured to:
generate the test code by inputting the target code description of the target data pair to the language model;
determine a second distance score between the test code and the target code of the target data pair; and
perform the second verification based on the second distance score.

17. The electronic device of claim 14, wherein, for the updating of the dataset based on the first verification and the second verification on the target data pair, the instructions, when executed individually or collectively by the at least one processor, further cause the electronic device to: in response to the first verification and the second verification on the target data pair being successful, keep the target data pair in the dataset.

18. The electronic device of claim 17, wherein, for the keeping of the target data pair in the dataset when the first verification and the second verification on the target data pair are successful, the instructions, when executed individually or collectively by the at least one processor, further cause the electronic device to: in response to the first verification and the second verification on the target data pair and operational verification on the target code being successful, keep the target data pair in the dataset.

19. The electronic device of claim 14, wherein, for the updating of the dataset based on the first verification and the second verification on the target data pair, the instructions, when executed individually or collectively by the at least one processor, further cause the electronic device to: in response to either one or both of the first verification and the second verification on the target data pair having failed, remove the target data pair from the dataset.

20. The electronic device of claim 14, wherein the instructions, when executed individually or collectively by the at least one processor, further cause the electronic device to train the language model using the updated dataset.
